(19) United States
(12) Patent Application Publication
(10) Pub. No.: US 2025/0139714 A1
(43) Pub. Date: May 1, 2025

(54) COLLABORATIVE ENVIRONMENTAL IMPACT OPTIMIZATION OF MANUFACTURING PROCESSES

(71) Applicant: BASF SE, Ludwigshafen am Rhein (DE)

(72) Inventors: Henning SCHWABE, Ludwigshafen am Rhein (DE); Tara BADRI, Florham Park, NJ (US); Nicole GRAF, Ludwigshafen am Rhein (DE)

(21) Appl. No.: 18/683,228

(22) PCT Filed: Aug. 12, 2022
(86) PCT No.: PCT/EP2022/072701

§ 371 Date: Feb. 12, 2024

(30) Foreign Application Priority Data
Aug. 13, 2021 (EP) 21191368.6

(51) Int. Cl. G06Q 50/04; G06Q 10/101

(52) U.S. Cl. CPC G06Q 50/04; G06Q 10/101

(57) ABSTRACT

A computer-implemented method for collaborative environmental impact optimization of manufacturing processes, the method comprising the steps of: receiving, by at least one processor and via a communication interface, first input data relating to at least one chemical product comprising environmental impact metrics data related to environmental impact metrics and product property data related to chemical or physical properties of the at least one chemical product; and second input data relating to at least one chemical product comprising environmental impact metrics data related to environmental impact metrics and product property data related to chemical or physical properties of the at least one chemical product; determining a first normalized environmental impact calculation model for the first input data, the first normalized environmental impact calculation model describing a functional relationship between the environmental impact metrics data and the product property data; and determining a second normalized environmental impact calculation model for the second input data, the second normalized environmental impact calculation model describing a functional relationship between the environmental impact metrics data and the product property data; connecting the first normalized environmental impact calculation model and the second normalized environmental impact calculation model to a connected normalized environmental impact calculation model; and providing, by the at least one processor, output data of the connected normalized environmental impact calculation model over a variable value range, and based on the output data optimizing the manufacturing processes.

### TECHNICAL FIELD

The present disclosure generally relates to a method and a device for collaborative environmental impact optimization of manufacturing processes, a computer program element, and a computer readable medium.

### TECHNICAL BACKGROUND

Manufactured materials are complex substances consisting of several components that are bonded together under specific process conditions. Materials are produced commercially to achieve certain application properties. In most cases, many different application properties play a role. It is often found that some of these properties are in conflict, i.e. if one is improved, the other deteriorates. Thus, it is necessary to find out how the application properties depend on the choice of components and process conditions in order to find the best compromise. The state of the art is to solve this problem iteratively in many steps using different technologies. These steps involve human understanding and decisions. Because of the iterative nature and the fact that specialized human knowledge is required, many decisions are made based on experience, i.e. based on the fact that the specialist has done similar things before. Environmental impact is very difficult to quantify for product offer evaluation, a need for transparent and certified environmental product information for selected products is present.

There may be a need to improve a system or a method for collaborative environmental impact optimization of manufacturing processes.

### SUMMARY

According to a first aspect of the present disclosure, there is provided to a computer-implemented method for collaborative environmental impact optimization of manufacturing processes, the method comprising the following steps of:

As a first step of the method, by at least one processor and via a communication interface, first input data relating to at least one chemical product comprising environmental impact metrics data related to environmental impact metrics and product property data related to chemical or physical properties of the at least one chemical product; and second input data relating to at least one chemical product comprising environmental impact metrics data related to environmental impact metrics and product property data related to chemical or physical properties of the at least one chemical product are received.

As a second step of the method, a first normalized environmental impact calculation model for the first input data, wherein the first normalized environmental impact calculation model is describing a functional relationship between the environmental impact metrics data and the product property data; and a second normalized environmental impact calculation model for the second input data, wherein the second normalized environmental impact calculation model is describing a functional relationship between the environmental impact metrics data and the product property data is determined.

As a third step of the method, the first normalized environmental impact calculation model for the first input data and the second normalized environmental impact calculation model for the second input data are connected to a connected normalized environmental impact calculation model.

As a fourth step of the method, by the at least one processor, output data of the connected normalized environmental impact calculation model over a variable value range are provided, and based on the output data optimizing the manufacturing processes.

A further aspect of the present disclosure relates to an apparatus for collaborative environmental impact optimization of manufacturing processes, the apparatus comprising:
one or more computing nodes and one or more computer-readable media having thereon computer-executable instructions that are structured such that, when executed by the one or more computing nodes, cause the apparatus to perform the following steps:
receiving, by at least one processor and via a communication interface, first input data relating to at least one chemical product comprising environmental impact metrics data related to environmental impact metrics and product property data related to chemical or physical properties of the at least one chemical product; and second input data relating to at least one chemical product comprising environmental impact metrics data related to environmental impact metrics and product property data related to chemical or physical properties of the at least one chemical product;
determining a first normalized environmental impact calculation model for the first input data, the first normalized environmental impact calculation model describing a functional relationship between the environmental impact metrics data and the product property data; and determining a second normalized environmental impact calculation model for the second input data, the second normalized environmental impact calculation model describing a functional relationship between the environmental impact metrics data and the product property data;
connecting the first normalized environmental impact calculation model and the second normalized environmental impact calculation model to a connected normalized environmental impact calculation model; and
providing, by the at least one processor, output data of the connected normalized environmental impact calculation model over a variable value range, and based on the output data optimizing the manufacturing processes.

A further aspect of the present disclosure relates to a system for collaborative environmental impact optimization of manufacturing processes, the system comprising:
a receiving unit configured to receive, by at least one processor and via a communication interface, first input data relating to at least one chemical product comprising environmental impact metrics data related to environmental impact metrics and product property data related to chemical or physical properties of the at least one chemical product (and optionally product identifier data, process and feedstock data); and second input data relating to at least one chemical product comprising environmental impact metrics data related to environmental impact metrics and product property data related to chemical or physical properties of the at least one chemical product (and optionally product identifier data, process and feedstock data);
a determining unit configured to determine a first normalized environmental impact calculation model for the first input data, the first normalized environmental impact calculation model describing a functional relationship between the environmental impact metrics data and the product property data; and a second normalized environmental impact calculation model for the second input data, the second normalized environmental impact calculation model describing a functional relationship between the environmental impact metrics data and the product property data;
a connecting unit configured to connect the first normalized environmental impact calculation model and the second normalized environmental impact calculation model to a connected normalized environmental impact calculation model; and
a providing unit configured to provide, by the at least one processor, output data of the connected normalized environmental impact calculation model over a variable value range, and based on the output data optimizing the manufacturing processes.

The object of the present disclosure is to improve a system or a method for collaborative environmental impact optimization of manufacturing processes. The object of the present disclosure is solved by the subject-matter of the independent claims, wherein further embodiments are incorporated in the dependent claims. It should be noted that the following described aspects of the disclosure apply also for the computer-implemented method, the device, the computer program element, and the computer readable medium.

Under Greenhouse Protocol a large share of Greenhouse gas emissions in manufacturing has be accounted for as emissions under scope 3. Likewise, several other adverse environmental and social impacts are tied to raw materials. The differentiation of the emission sources included according to the three scopes of the Greenhouse Protocol is well established: Scope 1 emissions originate from emission sources within the system boundaries under consideration, such as company-owned power plants or vehicle fleets; Scope 2 emissions arise from the generation of energy that is purchased from outside, this is primarily electricity and heat from energy services; Scope 3 emissions are all other emissions that are caused by the company's activities but are not under the company's control, for example at suppliers, service providers, employees or end consumers.

Scope 3 emissions are the result of activities from assets not owned or controlled by the reporting organization, but that the organization indirectly impacts in its value chain.

Since consumers, investors and regulators start to demand impact reduction all manufacturers have an interest to collaborate to reduce impacts on the level of the whole value chain.

Yet, both practical realities of profit maximization & anti-trust regulation make any straightforward collaborative approaches impractical. Instead, conflicting interests lead to inefficient and non-transparent bilateral negotiations.

The challenge is to enable suppliers and customers to use a joint optimization model of impact reduction on supply chain level without revealing any real data such as pricing, cost or capacity information regulated by anti-trust laws. Thus, each supply chain partner shall see the result of her decision on the joint impact reduction and economic benefit trade-off.

Bill of material for instance modelled by “is part of” relations, supplier relationships, product properties shall be visible only to contractual partners. Therefore, customers can access only data from high level or “tier 1” suppliers, i.e. suppliers with a visible track record of impact and close connection. On the other hand suppliers can access only data from high level or “tier 1” customers.

The present disclosure in advantageous solutions provides that product data is shared in a data processing system where supply chain participants control access rights to data and models stored in their node.

The term chemical product is to be understood broadly in the present case and comprises chemical products obtained from chemical reactions as well as natural chemical products. Natural chemical products encompass any chemical substance that is naturally occurring, i.e. any unprocessed chemical substance that is found in nature, such as chemicals from plants, micro-organisms, animals, the earth and the sea or any chemical substance that is found in nature and extracted using a process that does not change its chemical composition. Natural chemical products may include biologicals like enzymes as well naturally occurring inorganic or organic chemical products. Natural chemical products can be isolated and purified prior to their use or they can be used in unisolated and/or unpurified form. Chemical products obtained from chemical reactions may be any inorganic or organic chemical product obtained by reacting inorganic and/or organic chemical reactants. The inorganic and organic chemical reactants may be naturally occurring chemical products or can be chemical products obtained from chemical reactions. Chemical reactions may include any chemical reaction commonly known in the state of the art in which the reactants are converted to one or more different chemical products. Chemical reactions may involve the use of catalysts, enzymes, bacteria, etc. to achieve the chemical reaction between the reactants.

The environmental impact metrics data related to the environmental impact may indicate an environmental performance of one or more chemical products. The property related to the environmental impact may be associated with the environmental impact of one or more chemical products at any stage during its lifecycle. The stages of the product lifecycle may include the stages of providing raw material or components/parts to be used for producing a chemical precursor, producing a chemical precursor, producing a product using one or more chemical precursors, treating end-of-life products, recycling end-of-life products, disposing end-of-life products, reusing components from end-of-life products, or any subset of stages.

The environmental impact metrics data related to environmental impact may be specified or may be derived from any activity of one or more entities participating at any stage of the lifecycle of one or more product(s). The environmental impact metrics data related to the environmental impact may include one or more properties/characteristic(s) that are attributable to environmental impact of a product. The environmental impact metrics data related to environmental impact may include environmental, technical or circularity characteristics(s) associated with the environmental impact of one or more product(s). Environmental characteristic(s) may specify or quantify ecological criteria associated with the products environmental impact. Environmental characteristic(s) may be or may be derived from measurements taken during the lifecycle of one or more product(s). Environmental characteristics may be determined at any stage of the product lifecycle and may characterize the environmental impact of the product for such stage or up to such stage.

Environmental properties/characteristic(s) may for example include data related to carbon footprint, greenhouse gas emissions, resource usage, air emissions, ozone depletion potential, water pollution, noise pollution or eutrophication potential, biodegradability. Environmental characteristic(s) may for example include product characteristics related to the production of the product like bio based, vegan, halal, kosher, palm oil-free, natural or the like. Technical characteristic(s) may specify or quantify product performance at least indirectly associated with the environmental impact. Technical characteristic(s) may be or may be derived from measurements taken during the lifecycle of one or more product(s). Technical characteristics may be determined at any stage of the product lifecycle and may characterize the product performance for such stage or up to such stage. Technical characteristic(s) may for example include product composition data, bill of materials, product specification data, product component data, product safety data, application property data, application instructions or product quality data. Circularity characteristic(s) may specify or quantify the products life cycle characteristics associated with circular uses. Circularity characteristic(s) may be or may be derived from measurements taken during the lifecycle of one or more product(s). Circularity characteristic(s) may be or may be derived from circular data recorded in one or more prior lifecycle(s) including reuse. Circularity characteristics may be determined at any stage of the product lifecycle and may characterize the reuse or recycling performance for such stage or up to such stage. Circularity characteristic(s) may for example include recycling data, reuse rate, recycling rate, recycling loops, reuse reused product performance, reused product quality or the like.

The term emission data is to be understood broadly in the present case and comprises any data related to environmental footprint. The environmental footprint may refer to an entity and its associated environmental footprint. The environmental footprint may be entity specific. For instance, the environmental footprint may relate to a product, a company, a process such as a manufacturing process, a raw material or basic substance, a chemical product or material, a component, a component assembly, an end product, combinations thereof or additional entity-specific relations. Emission data may include data relating to carbon footprint of a chemical product. Emission data may include data relating to greenhouse gas emissions e.g. released in production of the chemical product. Emission data may include data related to greenhouse gas emissions. Greenhouse gas emissions may include emissions such as carbon dioxide (CO2) emission, methane (CH4) emission, nitrous oxide (N2O) emission, hydrofluorocarbons (HFCs) emission, perfluorocarbons (PFCs) emission, sulphurhexafluoride (SF6) emission, nitrogen trifluoride (NF3) emission, combinations thereof and additional emissions. Emission data may include data related to greenhouse gas emissions of an entities or companies own operations (production, power plants and waste incineration). Scope 2 comprise emissions from energy production, which is sourced externally. Scope 3 comprise all other emissions along the value chain. Specifically, this includes the greenhouse gas emissions of raw materials obtained from suppliers. Product Carbon Footprint (PCF) sum up greenhouse gas emissions and removals from the consecutive and interlinked process steps related to a particular product. Cradle-to-gate PCF sum up greenhouse gas emissions based on selected process steps: from the extraction of resources up to the factory gate where the product leaves the company. Such PCFs are called partial PCFs. In order to achieve such summation, each company providing any products must be able to provide the scope 1 and scope 2 contributions to the PCF for each of its products as accurately as possible, and obtain reliable and consistent data for the PCFs of purchased energy (scope 2) and their raw materials (scope 3).

The term product property data is to be understood broadly in the present case and comprises data related to a property of the chemical product and/or data related to the use of the chemical product. Such property may be a static or a dynamic property. A static property may be a property constant over time e.g. melting point, boiling point, density, hardness, flammability or the like. A dynamic property may be a property that changes over time e.g. shelf life, pH value, color, reactivity. Property of the chemical product may include performance properties, chemical properties, such as flammability, toxicity, acidity, reactivity, heat of combustion and/or physical properties such as density, color, hardness, melting and boiling points, electrical conductivity or the like. Data related to the use of the chemical product may include data related to further processing of the chemical product, for example by using the chemical product as reactant in further chemical reaction(s) and/or data related to the use of the chemical product, for example data related to the use of the chemical product in a treatment process and/or within a manufacturing process. Chemical product data may include chemicals data, emission data, recyclate content, bio-based content and/or production data.

The process and feedstock data may be understood as data defining or assigning a certain manufacturing process or chemical processing method used for instance for manufacturing the product. The term process may comprise any data related to the production of a chemical product at any stage in the chemical supply chain. Preferably, production data includes chemical production data from the production of the chemical product. Production data may include monitoring and/or control data associated with the production of the product, such as a raw material or basic substance, a chemical material or chemical product, a component, a component assembly, an end product or a combination thereof. Production data may include measurement data related to a product quality at any stage in the chemical supply chain, preferably a chemical product. The economic data may be understood as to define and describe economic parameters of the product.

The term normalized environmental impact calculation mode” as provided by the description of the present disclosure may be understood as a model used for decision making, planning and optimization, the model based on process data or product data, processes, product properties, and environmental ability impact calculations.

The term identifier data is to be understood broadly in the present case and comprises any identifier for a manufactured product. The identifier data may be understood as unique Identification Number in terms of a combination of digits or characters that uniquely identifies manufactured products, e.g. objects or entities in general within a certain category. The numbers may for instance be assigned in such a way that the same number is not assigned more than once to different entities. A reversibly unique relationship is also often required.

The term data owner is to be understood broadly in the present case and comprises any entity generating data. The generating node may be coupled to the entity owning physical products from or for which data is generated. The data may be generated by a third-party entity on behalf of the entity owning physical products from or for which data is generated.

The term chemical product data is to be understood broadly in the present case and comprises data related to a property of the chemical product and/or data related to the use of the chemical product. Such property may be a static or a dynamic property. A static property may be a property constant over time e.g. melting point, boiling point, density, hardness, flammability or the like. A dynamic property may be a property that changes over time e.g. shelf life, pH value, color, reactivity. Property of the chemical product may include performance properties, chemical properties, such as flammability, toxicity, acidity, reactivity, heat of combustion and/or physical properties such as density, color, hardness, melting and boiling points, electrical conductivity or the like. Data related to the use of the chemical product may include data related to further processing of the chemical product, for example by using the chemical product as reactant in further chemical reaction(s) and/or data related to the use of the chemical product, for example data related to the use of the chemical product in a treatment process and/or within a manufacturing process. Chemical product data may include chemicals data, emission data, recyclate content, bio-based content and/or production data.

The term downstream model as used by the present patent application may be considered for example as to referring to any model used for decision making, planning and optimization, the model based on process data or product data, processes, product properties, and environmental impact calculations, wherein the model is applied in a supply chain or a manufacturing chain in the direction from a product manufacturing source to a product sink, e.g. a customer.

The term upstream model as used by the present patent application may be considered for example as to referring to any model used for decision making, planning and optimization, the model based on process data or product data, processes, product properties, and environmental impact calculations, wherein the model is applied in a supply chain or a manufacturing chain in the direction from a product sink, e.g. a customer to a product manufacturing source.

The term data owner is to be understood broadly in the present case and comprises any entity generating data. The generating node may be coupled to the entity owning physical products from or for which data is generated. The data may be generated by a third-party entity on behalf of the entity owning physical products from or for which data is generated.

According to an embodiment of the present disclosure, as a first step, the first and second input data relating to at least one chemical product received, by the at least one processor and via a communication interface, further comprising product identifier data, process and/or feedstock data. These further data may further be used in the normalized environmental impact calculation models and/or when providing, by the at least one processor, output data of the connected normalized environmental impact calculation model over a variable value range, and for the optimizing of the manufacturing processes.

According to an embodiment of the present disclosure, the step of connecting the first normalized environmental impact calculation model and the second normalized environmental impact calculation model to a connected normalized environmental impact calculation model comprises: mapping selected product properties as output variables from at least one upstream model based on the first normalized environmental impact calculation model to input variables of at least one downstream model based on the second normalized environmental impact calculation model.

According to an embodiment of the present disclosure, the input variables of at least one downstream model are controlled by a first data owner or a second data owner; and/or wherein the input variables of at least one upstream model are controlled by the first data owner or the second data owner.

According to an embodiment of the present disclosure, the step of receiving, by the at least one processor and via the communication interface, input data of at least one chemical product further comprises: uploading of the input data of at least one chemical product data using a platform node.

According to an embodiment of the present disclosure, the step of uploading of the input data of at least one chemical product data using a platform node comprises uploading the input data to a secured computing enclave, in which statistical models are fitted by using statistical modeling code provided by an independent third party. This advantageously allows that all parties continuously run at least one trusted execution environment, TEE, also known as trusted computing enclave, on-premise or as Software as a Service. According to an embodiment of the present disclosure, a SaaS and can create additional TEEs on demand.

According to an embodiment of the present disclosure, a query is issued:

For example, an agent A receives from one of its data servers a bill of material of product identifiers sourced by actual and potential suppliers. In its continuously running TEE, agent A looks up agents with matching product IDs and Agent IDs in the joint lookup table (“phone book”) shared decentrally across all network nodes. Agent A sends queries to other agents in the network according to lookup result.

Finally a matching is determined: Agent B accepts query from A in its continuously running TEE and creates a second temporary TEE. The second TEE is specified via infrastructure as code to execute only the trusted consensus protocol.

According to an embodiment of the present disclosure, the method further comprises receiving, by the at least one processor and via a communication interface, economic data, and the economic data may also be used for determining a first normalized environmental impact calculation model based.

According to an embodiment of the present disclosure, the method further comprises the steps of: determining a third normalized environmental impact calculation model for third input data based on the environmental impact metrics data and the product property data (and optionally also on the process and feedstock data), the third normalized environmental impact calculation model describing a functional relationship between the environmental impact metrics data and the product property data; and connecting the first normalized environmental impact calculation model for the first input data and the second normalized environmental impact calculation model for the second input data and the third normalized environmental impact calculation model for the third input data to a connected normalized environmental impact calculation model.

According to an embodiment of the present disclosure, the step of providing, by the at least one processor, output data of the connected normalized environmental impact calculation model over a variable value range comprises restricting the variable value range to a valid and/or a predetermined variable value range.

The communication interface, for example, as an input unit, is configured to receive input data of at least one chemical product comprising environmental impact metrics data and product property data (and optionally product identifier data, process and feedstock data and/or economic data).

The at least one processor is configured to determine a first normalized environmental impact calculation model based on the environmental impact metrics data and the product property data (and optionally also based on the process and feedstock data, the economic data), the first normalized environmental impact calculation model describing a functional relationship between each one of the provided input data, e.g. the economic data, the environmental impact metrics data, the product property data, etc.

The at least one processor is configured to determine a second normalized environmental impact calculation model based on the environmental impact metrics data and the product property data (optionally further based on the process and feedstock data, the economic data), the second normalized environmental impact calculation model may describe a functional relationship between each one of the input data, e.g. the economic data, the environmental impact metrics data and the product property data, etc.

The at least one processor is configured to connect the first normalized environmental impact calculation model for the first user and the second normalized environmental impact calculation model to a connected normalized environmental impact calculation model.

The at least one processor may be configured to generate a user interface enabling evaluation of connected normalized environmental impact calculation model over a variable value range in terms of summing up the economic data, the environmental impact metrics data and the product property data.

The at least one processor may be configured to, based on the summing up, optimize the manufacturing processes. This may comprise controlling the manufacturing processes.

According to an embodiment of the present disclosure, the at least one processor is configured to connect the first normalized environmental impact calculation model and the second normalized environmental impact calculation model to a connected normalized environmental impact calculation model by mapping selected product properties as output variables from at least one upstream model based on the first normalized environmental impact calculation model to input variables of at least one downstream model based on the second normalized environmental impact calculation model.

According to an embodiment of the present disclosure, the communication interface is configured to upload the input data of at least one chemical product data using a platform node.

According to an embodiment of the present disclosure, the at least one processor is configured to determine a third normalized environmental impact calculation model for third input data based on the environmental impact metrics data and the product property data (and optionally further based on the process and feedstock data, the economic data), the third normalized environmental impact calculation model describing a functional relationship between each one of the economic data, the environmental impact metrics data and the product property data.

According to an embodiment of the present disclosure, the at least one processor is configured to connect the first normalized environmental impact calculation model and the second normalized environmental impact calculation model and the third normalized environmental impact calculation model to a connected normalized environmental impact calculation model.

According to an embodiment of the present disclosure, the at least one processor is configured to generate the user interface enabling evaluation of connected normalized environmental impact calculation model over the variable value range comprises restricting the variable value range to a valid variable value range.

As used herein, the term “unit” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logical circuit, and/or other suitable components that provide the described functionality.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the disclosure will be apparent from and elucidated with reference to the embodiment(s) described hereinafter.

### BRIEF DESCRIPTION OF THE DRAWINGS

In the drawings, like reference characters generally refer to the same parts throughout the different views. Further, the drawings are not necessarily to scale, emphasis instead generally being placed upon illustrating the principles of the disclosure.

FIG. 1 illustrate example embodiments of a centralized and a decentralized computing environment with computing nodes;

FIG. 2 illustrate example embodiments of a centralized and a decentralized computing environment with computing nodes;

FIG. 3 illustrate an example embodiment of a distributed computing environment;

FIG. 4 is a flowchart that illustrates a computer-implemented method according to some embodiments of the present disclosure;

FIG. 5 schematically illustrates a device according to some embodiments of the present disclosure;

FIG. 6 is a process flowchart that illustrates a computer-implemented method according to some embodiments of the present disclosure;

FIG. 7 is a diagram concerning a marginal impact reduction cost models for product x compared to reference product parameterized by independent variables models according to an exemplary embodiment of the present disclosure;

FIG. 8 is a diagram representing product properties models for product X parameterized by independent variables models according to an exemplary embodiment of the present disclosure; and

FIG. 9 is a diagram showing connected models according to an exemplary embodiment of the present disclosure.

### DETAILED DESCRIPTION OF EMBODIMENTS

The following embodiments are mere examples for implementing the method, the system, the apparatus, or application device disclosed herein and shall not be considered limiting.

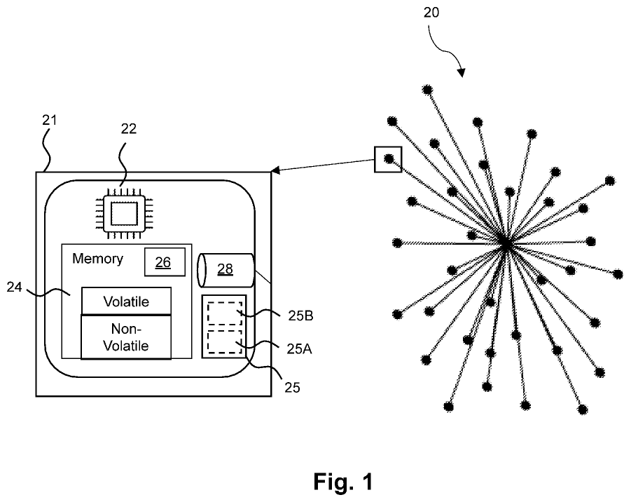

FIGS. 1 to 3 illustrate different computing environments, central, decentral and distributed. The methods, apparatuses, computer elements of this disclosure may be implemented in decentral or at least partially decentral computing environments. In particular, for data sharing or exchange in ecosystems of multiple players different challenges exist. Data sovereignty may be viewed as a core challenge. It can be defined as a natural person's or corporate entity's capability of being entirely self-determined with regard to its data. To enable this particular capability related aspects, including requirements for secure and trusted data exchange in business ecosystems, may be implemented across the chemical value chain. In particular, chemical industry requires tailored solutions to deliver chemical products in a more environmental friendly/sustainable way by using digital ecosystems. Providing, determining or processing of data may be realized by different computing nodes, which may be implemented in a centralized, a decentralized or a distributed computing environment.

FIG. 1 illustrates an example embodiment of a centralized computing system 20 comprising a central computing node 21 (filled circle in the middle) and several peripheral computing nodes 21.1 to 21.n (denoted as filled circles in the periphery). The term “computing system” is defined herein broadly as including one or more computing nodes, a system of nodes or combinations thereof. The term “computing node” is defined herein broadly and may refer to any device or system that includes at least one physical and tangible processor, and/or a physical and tangible memory capable of having thereon computer-executable instructions that are executed by a processor. Computing nodes are now increasingly taking a wide variety of forms. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In this example, the peripheral computing nodes 21.1 to 21.n may be connected to one central computing system (or server). In another example, the peripheral computing nodes 21.1 to 21.n may be attached to the central computing node via e.g. a terminal server (not shown). The majority of functions may be carried out by, or obtained from the central computing node (also called remote centralized location). One peripheral computing node 21.n has been expanded to provide an overview of the components present in the peripheral computing node. The central computing node 21 may comprise the same components as described in relation to the peripheral computing node 21.n.

Each computing node 21, 21.1 to 21.n may include at least one hardware processor 22 and memory 24. The term “processor” may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor based processor, a quantum processor, or any other type of processor configures for processing instructions. As an example, the processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processor may be a multicore processor. Specifically, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

The memory 24 may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

The computing nodes 21, 21.1 to 21.n may include multiple structures 26 often referred to as an “executable component, executable instructions, computer-executable instructions or instructions”. For instance, memory 24 of the computing nodes 21, 21.1 to 21.n may be illustrated as including executable component 26. The term “executable component” or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 21, 21.1 to 21.n, whether such an executable component exists in the heap of a computing node 21, 21.1 to 21.n, or whether the executable component exists on computer-readable storage media. In such a case, one of ordinary skill in the art will recognize that the structure of the executable component exists on a computer-readable medium such that, when interpreted by one or more processors of a computing node 21, 21.1 to 21.n (e.g., by a processor thread), the computing node 21, 21.1 to 21n is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the terms “component”, “agent”, “manager”, “service”, “engine”, “module”, “virtual machine” or the like are used synonymous with the term “executable component.

The processor 22 of each computing node 21, 21.1 to 21.n may direct the operation of each computing node 21, 21.1 to 21.n in response to having executed computer-executable instructions that constitute an executable component. For example, such computer-executable instructions may be embodied on one or more computer-readable media that form a computer program product. The computer-executable instructions may be stored in the memory 24 of each computing node 21, 21.1 to 21.n. Computer-executable instructions comprise, for example, instructions and data which, when executed at a processor 21, cause a general purpose computing node 21, 21.1 to 21.n, special purpose computing node 21, 21.1 to 21.n, or special purpose processing device to perform a certain function or group of functions. Alternatively or in addition, the computer-executable instructions may configure the computing node 21, 21.1 to 21.n to perform a certain function or group of functions. The computer executable instructions may be, for example, binaries or even instructions that undergo some translation (such as compilation) before direct execution by the processors, such as intermediate format instructions such as assembly language, or even source code.

Each computing node 21, 21.1 to 21.n may contain communication channels 28 that allow each computing node 21.1 to 21.n to communicate with the central computing node 21, for example, a network (depicted as solid line between peripheral computing nodes and the central computing node in FIG. 1). A “network” may be defined as one or more data links that enable the transport of electronic data between computing nodes 21, 21.1 to 21.n and/or modules and/or other electronic devices. When information is transferred or provided over a network or another communications connection (either hardwired, wireless, or a combination of hardwired or wireless) to a computing node 21, 21.1 to 21.n, the computing node 21, 21.1 to 21.n properly views the connection as a transmission medium. Transmission media can include a network and/or data links which can be used to carry desired program code means in the form of computer-executable instructions or data structures and which can be accessed by a general-purpose or special-purpose computing nodes 21, 21.1 to 21.n. Combinations of the above may also be included within the scope of computer-readable media.

The computing node(s) 21, 21.1 to 21.n may further comprise a user interface system 25 for use in interfacing with a user. The user interface system 25 may include output mechanisms 25A as well as input mechanisms 25B. The principles described herein are not limited to the precise output mechanisms 25A or input mechanisms 25B as such will depend on the nature of the device. However, output mechanisms 25A might include, for instance, displays, speakers, displays, tactile output, holograms and so forth. Examples of input mechanisms 25B might include, for instance, microphones, touchscreens, holograms, cameras, keyboards, mouse or other pointer input, sensors of any type, and so forth.

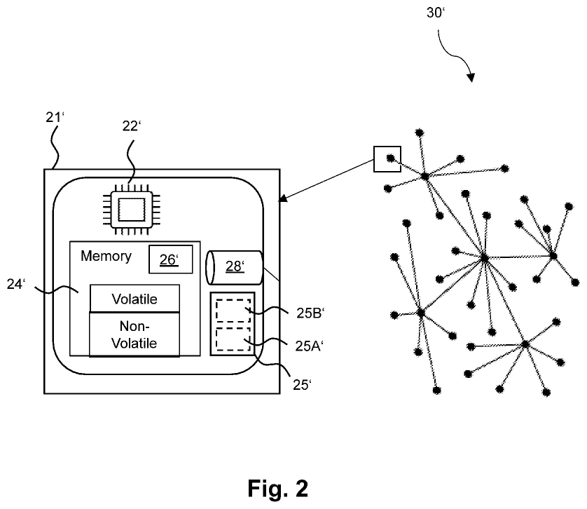

FIG. 2 illustrates an example embodiment of a decentralized computing environment 30 with several computing nodes 21.1 to 21.n denoted as filled circles. In contrast to the centralized computing environment 20 illustrated in FIG. 1, the computing nodes 21.1 to 21.n of the decentralized computing environment are not connected to a central computing node 21 and are thus not under control of a central computing node. Instead, resources, both hardware and software, may be allocated to each individual computing node 21.1 to 21.n (local or remote computing system) and data may be distributed among various computing nodes 21.1 to 21.n to perform the tasks. Thus, in a decentral system environment, program modules may be located in both local and remote memory storage devices. One computing node 21 has been expanded to provide an overview of the components present in the computing node 21. In this example, the computing node 21 comprises the same components as described in relation to FIG. 1.

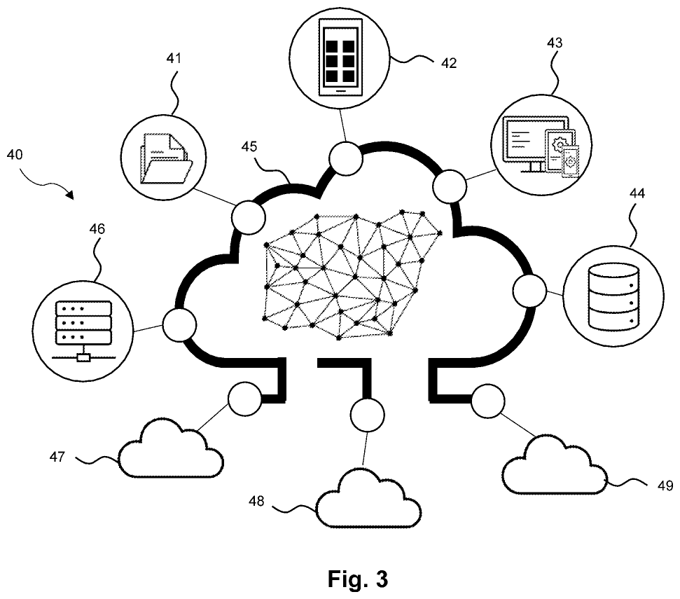

FIG. 3 illustrates an example embodiment of a distributed computing environment 40. In this description, “distributed computing” may refer to any computing that utilizes multiple computing resources. Such use may be realized through virtualization of physical computing resources. One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations. In this example, the distributed cloud computing environment 40 may contain the following computing resources: mobile device(s) 42, applications 43, databases 44, data storage and server(s) 46. The cloud computing environment 40 may be deployed as public cloud 47, private cloud 48 or hybrid cloud 49. A private cloud 47 may be owned by an organization and only the members of the organization with proper access can use the private cloud 48, rendering the data in the private cloud at least confidential. In contrast, data stored in a public cloud 48 may be open to anyone over the internet. The hybrid cloud 49 may be a combination of both private and public clouds 47, 48 and may allow to keep some of the data confidential while other data may be publicly available.

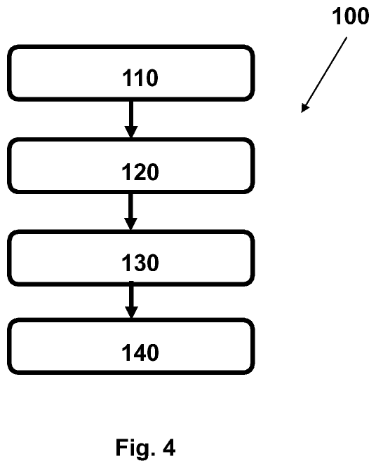

FIG. 4 is a flowchart that illustrates an example of the computer-implemented method 100 according to the first aspect of the present disclosure.

The computer-implemented method 100 comprises the steps of:

As a first step of the method, by at least one processor and via a communication interface, first input data relating to at least one chemical product comprising environmental impact metrics data related to environmental impact metrics and product property data related to chemical or physical properties of the at least one chemical product (and optionally product identifier data, process and feedstock data); and second input data relating to at least one chemical product comprising environmental impact metrics data related to environmental impact metrics and product property data related to chemical or physical properties of the at least one chemical product (and optionally product identifier data, process and feedstock data) are received 110.

As a second step of the method, a first normalized environmental impact calculation model for the first input data, the first normalized environmental impact calculation model describing a functional relationship between the environmental impact metrics data and the product property data; and determining a second normalized environmental impact calculation model for the second input data, the second normalized environmental impact calculation model describing a functional relationship between the environmental impact metrics data and the product property data are determined 120.

As a third step of the method, the first normalized environmental impact calculation model and the second normalized environmental impact calculation model to a connected normalized environmental impact calculation model are connected 130.

As a fourth step of the method, by the at least one processor, output data of the connected normalized environmental impact calculation model over a variable value range are provided 140, and based on the output data optimizing the manufacturing processes. Here it is also possible that, by the at least one processor, a user interface is generated/provided enabling an evaluation of the connected normalized environmental impact calculation model over a variable value range in terms of summing up the economic data, the environmental impact metrics data and the product property data. Based on such a summing up, an optimization of the manufacturing processes may also be performed and/or controlled. The summing of the economic data, the environmental impact metrics data and the product property data may result in calculating a control parameter, which may be used to perform the optimization and the controlling of the manufacturing processes.

The computer-implemented method 100 may be implemented as a device, module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

The present disclosure advantageously solves the problem that in a digital supply chain, automated agents (such as agents executing process model-based decision and optimization routines) require input data from other automated agents (suppliers or customers) to calculate model parameters. Models describe manufacturing processes, product properties, and environmental impacts of both. However, the input data required from supply chain partners is in all likelihood proprietary.

Even the fact that a partner is interested to request the data in the first place could constitute a confidential fact. Because of the deep integration required by automated agents input data needs to be more detailed and formalized than today at human-to-human interfaces. Formalization is achieved by consensus on shared semantic models comprising data formats and types, rules, and meaning of variable names.

Thus, the overall problem to solve is: Exchange detailed values and semantics of input data between supply chain partners without revealing proprietary information in a high security data processing environment and guarantee that this transfer is executed using a consensus protocol that is openly accessible for review by all eligible partners.

The present disclosure advantageously provides the solution that agents in a digital supply chain and manufacturing peer-to-peer network control manufacturing processes using models for decision making, planning and optimization comprising process and product data, processes, product properties, and environmental impact calculations.

The present disclosure advantageously provides the solution that parties run trusted computing enclaves on-premise or as SaaS. Agents need to calculate parameters for their models from input data based on standardized industry consensus protocol that is accessible to network partners. Protocol is provisioned by trusted network service. Input to protocol is own proprietary data and those of selected counterparts in the supply chain.

Query: Agent A has a bill of material of product identifiers sourced by actual and potential suppliers. A looks up agents with matching product IDs and queries them for data availability. Matching: Agent B accepts query from A and a trusted computing enclave is created by B. Enclave is specified via infrastructure as code to execute only the trusted consensus protocol. Key exchange (prior art): The protocol in the enclave issues one key pair 1 for data of B and one key pair 2 for data of A signed with the trusted ID of the protocol. The protocol requests data from A and B via signed query. Agent A and B verify certificate of protocol and send their data signed by their certificates via encrypted channel. Protocol checks certificates of agent A and B.

Calculation: Protocol calculates results as per input data request & returns specified results to A and B via encrypted channels and then deletes itself and all the data received or generated. B never sees the input data by A specifying the request. A receives calculated parameters. A and B receive error status of protocol.

Chain extension: B on receiving the data request from the protocol determines that itself executes a calculation first before it can answer the query by the protocol triggered by A. Thus, B starts a query as A above & the query chain is extended.

For example, computer program code to carry out operations shown in the method 100 may be written in any combination of one or more programming languages, including an object oriented programming language such as JAVA, SMALLTALK, C++, Python, or the like and conventional procedural programming languages, such as the “C” programming language or similar programming languages.

### Environmental Impact Calculation Model/System Model

In the method, an environmental impact calculation model is provided via an input channel based on user input data of at least one chemical product. The environmental impact calculation model may comprise system models associates a set of design parameters with a plurality of objective parameters that represent design characteristics of a system.

In an example, the system model may comprise a linear model. Alternatively, the system model may comprise a nonlinear model including at least one dimension reduction step.

Examples of the linear or nonlinear model may include, but are not limited to,
linear regression;
principal component regression;
partial least squares regression;
ridge regression;
a lasso model;
a model whose mathematical form is given by polynomials;
a model whose mathematical form is given by a linear combination of arbitrary ansatz functions, such as, but not limited to, sine and cosine functions as appearing in Fourier Series, exponential functions as appearing as basis for complete monotonic functions, Gaussian Functions, Bessel Functions, Spherical Harmonics, logarithmic functions, rational functions, etc. or any algebraic expression formed from these functions;
a model whose mathematical form is given by polynomials of first or second order;
a model whose mathematical form is given by polynomials whose coefficients are determined by at least one of the following algorithms: linear regression, principal component regression, partial least square regression, ridge regression, lasso or any combination thereof;
a model whose mathematical form is given by polynomials of first or second order whose coefficients are determined by at least one of the following algorithms: linear regression, principal component regression, partial least square regression, ridge regression, lasso or any combination thereof;
a model whose mathematical form is given by a linear combination of arbitrary ansatz functions, such as, but not limited to, sine and cosine functions as appearing in Fourier Series, exponential functions as appearing as basis for complete monotonic functions, Gaussian Functions, Bessel Functions, Spherical Harmonics, logarithmic functions, rational functions, etc. or any algebraic expression formed from these functions, whose coefficients are determined by at least one of the following algorithms: linear regression, principal component regression, partial least square regression, ridge regression, lasso or any combination thereof;
any kind of parametric model, such as, but not limited to, polynomial regression models and neural network models;
a nonparametric models, such as, but not limited to, Spline Interpolation, Gaussian Process Models, Multivariate Adaptive Regression Spline, Kernel Regression;
any model, including any one of the explicit possibilities above, built on a previous dimension reduction step, such as, but not limited to, Feature selection, Feature projection, Feature extraction, Principal component analysis (PCA), Non-negative matrix factorization, Kernel PCA, Graph-based kernel PCA, Linear discriminant analysis, Generalized discriminant analysis, Autoencoder, T-distributed Stochastic Neighbour Embedding, Uniform manifold approximation and projection, K-nearest neighbours algorithm, canonical-correlation analysis, low-dimensional embedding, fast approximate K-NN search, locality sensitive hashin, random projection, Multilinear subspace learning, Multilinear principal component analysis, Multilinear independent component analysis, Multilinear linear discriminant analysis, Multilinear canonical correlation analysis, Independent component analysis, Isomap, Kernel PCA, Latent semantic analysis, Partial least squares, Principal component analysis, Multifactor dimensionality reduction, Nonlinear dimensionality reduction, Multilinear Principal Component Analysis, Multilinear subspace learning, Semidefinite embedding, Autoencoder;
any model based on any of the above listed techniques applied on an experimental data set;
any model based on any of the above listed techniques applied on an experimental data set generated by a Design of Experiments approach, such as, but not limited to full factorial designs, fractional factorial designs, D-Optimal designs; or
a model defined by combinations and/or functions and/or chains of the models, functions, and/or algorithms listed above.

In the following, x₁, x₂, . . . , xₙ represent the set of design parameters of the considered system model. The set of design parameters may be e.g. original control and/or input parameters of the considered system.

Further, y₁, y₂, . . . , yₖ represent the plurality of objective parameters of the considered system model. Examples of the objective parameters may be e.g. response and target variables of interest.

The range of the design parameters, i.e. input variables, is typically limited by a set of constrains. Both linear and nonlinear functions may be covered. Typically, but not limited to this case, we consider linear constrains of at least one of the following forms:

$${al}_{1} \cdot {x}_{1} + {al}_{2} \cdot {x}_{2} + … + {al}_{n} \cdot {x}_{n} > cl ; \qquad ( a )$$

$${al}_{1} \cdot {x}_{1} + {al}_{2} \cdot {x}_{2} + … + {al}_{n} \cdot {x}_{n} < cl ; or \qquad ( b )$$

$${al}_{1} \cdot {x}_{1} + {al}_{2} \cdot {x}_{2} + … + {al}_{n} \cdot {x}_{n} = cl . \qquad ( c )$$

The coefficients al and cl are arbitrary numbers. Typically, but not restricted to this case, the defined constrains may encode prior knowledge of a system expert, and may be based, but not limited to, both on practical experience and theoretical considerations such as fundamental, empirical, or semi-empirical physical, chemical, or technical formulas.

Further, z₁, z₂, . . . , zₘ with m<n represent a set of “latent variables”, such as, but not limited to, results from a principal components analysis (PCA) based on x₁, . . . , xₙ, or latent variables of a partial least squares (PLS) regression model connecting x₁, . . . , xₙ, and y₁, . . . , yₖ via the latent variables z₁, . . . , zₘ.

We assume a validated model, such as, but not limited to, a PCA or PLS regression, that can with sufficiently accuracy predict y₁, . . . , yₖ from x₁, . . . , xₙ via z₁, . . . , zₘ:

x₁, . . . ,xₙ=>z₁, . . . ,zₘ=>y₁, . . . ,yₖ.

Generalizations to arbitrary nonlinear models including a dimension reduction steps shall also be covered, such as, but not limited to auto-encoders, neural networks, and the like.

The system model may comprise at least one of the following models.

### A. Chemical Formulations

In an example, the system model may be used to model chemical formulations, e.g. for predicting the properties of a chemical mixture. Examples of the chemical mixture may include, but are not limited to, paint formulation, agricultural multi-component mixture, pharmaceutical multi-component mixture, nutrition multi-component mixture, ink multi-component mixture, chemical mixture for construction purposes, and chemical mixture used inside oil production.

The design parameters, i.e. input variables, of the model for predicting the properties of a chemical mixture may include chemical mixture recipes having two or more ingredients. In some examples, a single chemical mixture recipe may comprise up to fifty different raw materials, i.e. ingredients. The two or more ingredients are expressed as fractional concentrations of the total amount of the chemical mixture. In general, the property of a chemical mixture depends on the ingredient component fractional concentrations rather than the total amount of the chemical mixture. Mixture formulas may be expressed in weight, volume, or other quantity units, such as the relative concentration of reactive groups per monomer type if mixtures of monomers with different amount of functional groups per monomer are considered. The fractional concentration is simply the quantity of an ingredient in the chemical mixture divided by the total quantity of the mixture. The sum of the fractional concentrations will be unity. Fractional concentrations are continuous variable in the range between 0 and 1.

Many times the properties of mixtures depend on process conditions in addition to the mixture components. For example, environmental variables may influence a property measurement. In the coating example, the temperature of the mixture during measurement can influence the measurement of viscosity. Therefore, process variables, such as temperature, may also be included as a design parameter.

The plurality of objective parameters of the model for predicting the properties of a chemical mixture may comprise properties of the chemical mixture. Properties of the chemical mixture may be any measurable characteristic. The characteristic may be a continuous, ordinal, or nominal measurement. For example, a formulated coating could have a measurement of the viscosity of the liquid mixture on a continuous scale. For example, the measurement of orange peel of the applied coating film may be on a decimal category ordinal scale from 1 (very unsmooth) to 10 (very smooth). In another example, the properties of each chemical mixture recipe further comprise, for each measured property, a respective performance score indicative of a performance evaluation of the respective chemical mixture recipe, e.g. from 1 (very good) to 5 (very bad). An example of a nominal measurement may be the coded categories of pass or fail for observation of some defect.

In the following, exemplary design parameters (e.g. raw materials) and exemplary objective parameters (e.g. properties) for various chemical mixtures will described.

### 1. Agricultural Multi-Component Mixtures

For example, there are mixtures used for agricultural purposes like formulations used as sprays for treating crops with insecticides, fungicides and so on. Thereby on the one side the sprayability of the active ingredients is guaranteed by the residual components inside the formulation. I.e. the different other components of the formulation besides the active ingredient are used to obtain a formulation, which is applicable under the given process of spraying. I.e. the sprayability (e.g. droplet size formation, ease of forming such a droplet and so on) might be properties, which are influenced by the different components of such a formulation together with the nature of the active ingredient.

Furthermore, also the adsorption of the sprayed formulation on the plant and the absorption, which is resorption in this context, of the active ingredient or complete sprayed formulation are depending on the active ingredient and the residual components in the formulation. Moreover, also the target-oriented way—or better said movement of the active ingredient to the targeted part of the cell—of the active ingredient inside a plant/organism will be influenced by the residual components inside such a formulation. I.e. the speed of effect generation and the effect generation itself are depending on these shares of the formulation.

### 2. Pharmaceutical Multi-Component Mixtures

Also, here the components being present in a pharmaceutical formulation besides the active ingredient influence the complete lifecycle of such a pharmaceutical-herein, from preparation to excretion or “digestion”.

For example, these formulation shares define, whether an active ingredient is provided as pill, suppositories or as a liquid, which mostly is a dispersion of the active ingredient.

Furthermore, these formulation shares define, where inside an organism the active ingredient is set free and where it can be absorbed respectively resorbed.

Finally, these formulation shares define, to which parts inside a body respectively cell the active ingredient is transported and there digested to show the wished effect; or, if it is not “digested” inside the organism at all and excreted without “digestion”.

Each of these properties may be important to find the right formulation, i.e. composition of the pharmaceutical multi-component mixtures.

### 3. Nutrition Multi-Component Mixtures

Many foods can be looked at as multi-component mixtures comprising different kind of chemical sub-groups necessary for our organisms to work properly. Nutrition additives like e.g. vitamins, mineral nutrients and so on are a part of foods also, whereby it is important to integrate these into these food “formulations” in a way that these are available at the right parts of the organism. Again, both parameters can be influenced by the residual shares of the food “formulations”. For example, the right way of offering mineral nutrients to an organism can guarantee a good resorption by the organism, whereas a worse way of offering can reduce the resorption, what then can cause health effects.

### 4. Inks as Multi-Component Mixtures

Similar, inks are also multi-component mixtures, i.e. they can be defined as ink formulations also. Also, here the residual components beside the colour providing ingredients—in this case mostly dyes—guarantee the stability of the ink, the process-ability and the fixation on the to-be-inked surface.

Here, the properties being of specific importance, are properties like adhesion to the to-be-inked surface, sagging resistance or viscosity stability of the formulation after application and lightfastness of the resulting print, i.e. non-fading of the resulting print.

### 5. Chemical Mixtures for Construction Purposes

Also, a lot of materials used inside construction applications can be looked at as chemical mixtures. E.g. concrete is formed out of a mixture of cement, rockets of different sizes and water. Furthermore, a modern concrete formulation also contains concrete additions and concrete admixtures, both, additives for these formulations to trigger and tailor-make specific properties of the concrete formulations. Such properties are for example the application behaviour, the settling behaviour, the hardening, the tensile strength, the bending property and the durability of the concrete in wet or in dried form. All these properties can be influenced by concrete additions and concrete admixtures. Whereas the substances used as concrete addition materials are mostly inorganics like e.g. rock flour, fly ash or silica fume, the substances used as concrete admixture materials can also be of organic character, like e.g. acrylics or other oligo- or polymeric substances.

A related application may also be chemical mixtures used as materials for plastering. Thereby, also formulations are used, which are similar to concrete formulations. However, these plaster mortars are usually limited with respect to the size of the rockets. I.e. the rock's aggregate is limited to a size of 4 mm, no bigger sizes are allowed to be used for these mortars. The main properties, which need to be achieved also by the use of the right additives, which are very similar to the ones mentioned above, are mainly in the area of application properties respectively workability. Pumpability, smoothing property, but also adhesion properties are evaluated usually during the development of such plastering formulations.

### 6. Chemical Mixtures Used Inside Oil Production

Also, in oil production chemical mixtures are used to optimize the degree of efficiency of oil extraction. In fracking and in conventional oil extraction methods, especially at late stages of the lifecycle of a wellbore, the efficiency level is elevated by pumping of these formulations into the wellbore. Thereby, mainly water comprising organic polymers are used. Overall, the efficiency level of oil production is a parameter for the effectiveness of the additives used. In a detail view, properties like the ability to release oil from stones or the ability to generate pressure and viscosity under such conditions might be important properties.

### B. Chemical Processes

In an example, the model may be used for modelling chemical processes.

Using the industrial aging processes as an example, aging of critical assets is an omnipresent phenomenon in any production environment, causing significant maintenance expenditures or leading to production losses. The understanding and anticipation of the underlying degradation processes is therefore of great importance for a reliable and economic plant operation, both in discrete manufacturing and in the process industry.

With a focus on the chemical industry, notorious aging phenomena include the deactivation of heterogeneous catalysts due to coking, sintering, or poisoning; plugging of process equipment, such as heat exchangers or pipes, on process side due to coke layer formation or polymerization; fouling of heat exchangers on water side due to microbial or crystalline deposits; erosion of installed equipment, such as injection nozzles or pipes, in fluidized bed reactors; and more.

This understanding has commonly been condensed into sophisticated mathematical models. Examples of such mechanistic degradation models deal with coking of steamcracker furnaces, sintering or coking of heterogeneous catalysts, or crystallization fouling of heat exchangers.

In this example, the design parameters may thus include various process variables, such as temperature, flow rate, pressure, etc., while the objective parameters may include one or more key performance indicators for quantifying the progress of its degradation.

One skilled in the art would understand that the method of the present disclosure is also applicable for other system models, such as logistics system model, energy system models, engineering system models, etc.

### Optimization Objective Parameters

In the method, environmental impact calculation model may be based on input data, e.g. also user input data, which may include a parameter identification process for each environmental impact calculation model. The optimization objective parameters of the environmental impact calculation model may be also referred to as optimization targets.

The optimization objective parameters may be essential objectives to be optimized or optional objectives to be optimized.

For example, in chemical process design two levels of objective criteria are often considered: design criteria and final decision criteria. The first group may contain, e.g. product purities, column duties, and reboil ratios. The second group may comprise hard economic objectives like investment and operating costs, often more softer environmental issues as environmental key figures and objectives regarding health and safety.

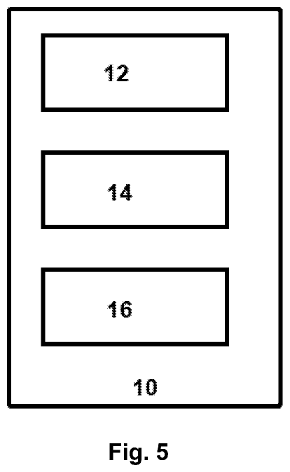

FIG. 5 schematically illustrates an example of the device 10 according to the second aspect of the present disclosure. The device 10 may be implemented as an embedded computing device or on a personal computer, for example.

The device 10 for collaborative environmental impact optimization of manufacturing processes may comprise a communication interface 12, at least one processor 14, and a user interface 16.

The input unit or communication interface 12 is configured to receive a user input data of at least one chemical product comprising environmental impact metrics data and product property data and optionally product identifier data, process and feedstock data, economic data.

The at least one processor 14 is configured to determine a first normalized environmental impact calculation model for a first user based on the environmental impact metrics data and the product property data (and optionally also based the process and feedstock data, the economic data), the first normalized environmental impact calculation model describing a functional relationship between each one of the input data, e.g. the economic data, the environmental impact metrics data, the product property data, etc. for the first user.

The at least one processor 14 is configured to determine a second normalized environmental impact calculation model for a second user based on the environmental impact metrics data and the product property data (and optionally also based on the process and feedstock data, the economic data), the second normalized environmental impact calculation model describing a functional relationship between each one of the input data, e.g. the economic data, the environmental impact metrics data, the product property data, etc. for the second user.

The at least one processor 14 is configured to connect the first normalized environmental impact calculation model for the first user and the second normalized environmental impact calculation model for the second user to a connected normalized environmental impact calculation model.

The at least one processor 14 is configured to generate the user interface 16, which is configured to enable evaluation of connected normalized environmental impact calculation model over a variable value range in terms of summing up the economic data, the environmental impact metrics data and the product property data. The at least one processor 14 is configured to optimize and control the manufacturing processes. The manufacturing/production of a chemical product may comprise a two-step process: 1) production of precursor material, 2) production of the chemical product. To produce the precursor material, raw materials may be used as physical inputs. The operating system of the precursor production may access data related to the raw materials based. Such data may be used to operate the production. For instance, if the raw materials are recycled materials, production steps purifying the recyclate may be comprised. For instance, if the raw materials are virgin materials, purification steps may be omitted. The precursor material may be formed by co-precipitating the raw materials. In a second step, the precursor material may be provided to produce the chemical product. The precursor material may comprise the precursor produced by the precursor production. The precursor material may comprise recycled precursor material or precursor material produced by a different entity.

A skilled person will appreciate that the device is also applicable for a logistics system model, an energy system model, an engineering system model, and the like.

The system model may comprise a linear model or a nonlinear model including at least one dimension reduction step. Examples of the linear or nonlinear model may include, but are not limited to:
linear regression;
principal component regression;
partial least squares regression;
ridge regression;
a lasso model;
a model whose mathematical form is given by polynomials;
a model whose mathematical form is given by a linear combination of arbitrary ansatz functions, such as, but not limited to, sine and cosine functions as appearing in Forier Series, exponential functions as appearing as basis for complete monotonic functions, Gaussian Functions, Bessel Functions, Spherical Harmonics, logarithmic functions, rational functions, etc. or any algebraic expression formed from these functions;
a model whose mathematical form is given by polynomials of first or second order;
a model whose mathematical form is given by polynomials whose coefficients are determined by at least one of the following algorithms: linear regression, principal component regression, partial least square regression, ridge regression, lasso or any combination thereof;
a model whose mathematical form is given by polynomials of first or second order whose coefficients are determined by at least one of the following algorithms: linear regression, principal component regression, partial least square regression, ridge regression, lasso or any combination thereof;
a model whose mathematical form is given by a linear combination of arbitrary ansatz functions, such as, but not limited to, sine and cosine functions as appearing in Forier Series, exponential functions as appearing as basis for complete monotonic functions, Gaussian Functions, Bessel Functions, Spherical Harmonics, logarithmic functions, rational functions, etc. or any algebraic expression formed from these functions, whose coefficients are determined by at least one of the following algorithms: linear regression, principal component regression, partial least square regression, ridge regression, lasso or any combination thereof;
any kind of parametric model, such as, but not limited to, polynomial regression models and neural network models;
a nonparametric models, such as, but not limited to, Spline Interpolation, Gaussian Process Models, Multivariate Adaptive Regression Spline, Kernel Regression;
any model, including any one of the explicit possibilities above, built on a previous dimension reduction step, such as, but not limited to, Feature selection, Feature projection, Feature extraction, Principal component analysis (PCA), Non-negative matrix factorization, Kernel PCA, Graph-based kernel PCA, Linear discriminant analysis, Generalized discriminant analysis, Autoencoder, T-distributed Stochastic Neighbor Embedding, Uniform manifold approximation and projection, K-nearest neighbors algorithm, canonical-correlation analysis, low-dimensional embedding, fast approximate K-NN search, locality sensitive hashin, random projection, Multilinear subspace learning, Multilinear principal component analysis, Multilinear independent component analysis, Multilinear linear discriminant analysis, Multilinear canonical correlation analysis, Independent component analysis, Isomap, Kernel PCA, Latent semantic analysis, Partial least squares, Principal component analysis, Multifactor dimensionality reduction, Nonlinear dimensionality reduction, Multilinear Principal Component Analysis, Multilinear subspace learning, Semidefinite embedding, Autoencoder;
any model based on any of the above listed techniques applied on an experimental data set;
any model based on any of the above listed techniques applied on an experimental data set generated by a Design of Experiments approach, such as, but not limited to full factorial designs, fractional factorial designs, D-Optimal designs; or
a model defined by combinations and/or functions and/or chains of the models, functions, and/or algorithms listed above.

Thus, the communication interface 12 is, in an example, implemented as an Ethernet interface, a USB™ interface, a wireless interface such as a Wi-Fi™ or Bluetooth™, or 5G or 6G, or any comparable data transfer interface enabling data transfer between input peripherals and the processing unit or at least one processor 14.

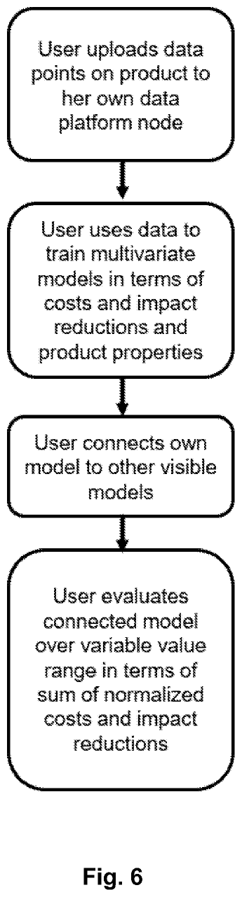

FIG. 6 is a process flowchart that illustrates a computer-implemented method according to some embodiments of the present disclosure.

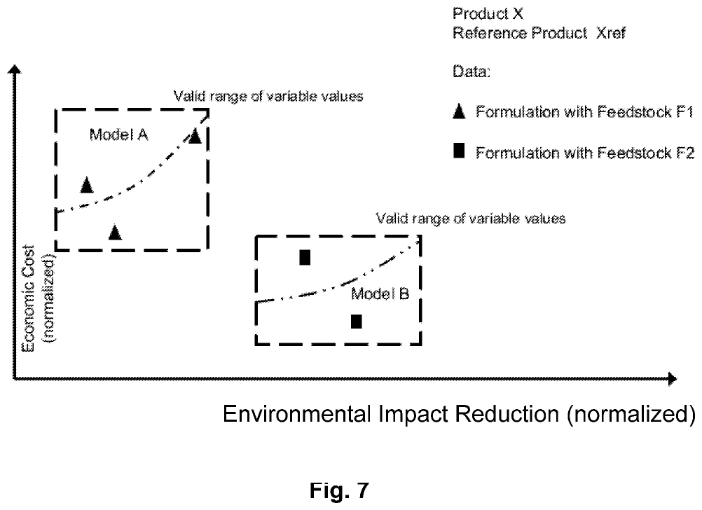

FIG. 7 is a diagram concerning a marginal impact reduction cost models for product x compared to reference product parameterized by independent variables models according to an exemplary embodiment of the present disclosure.

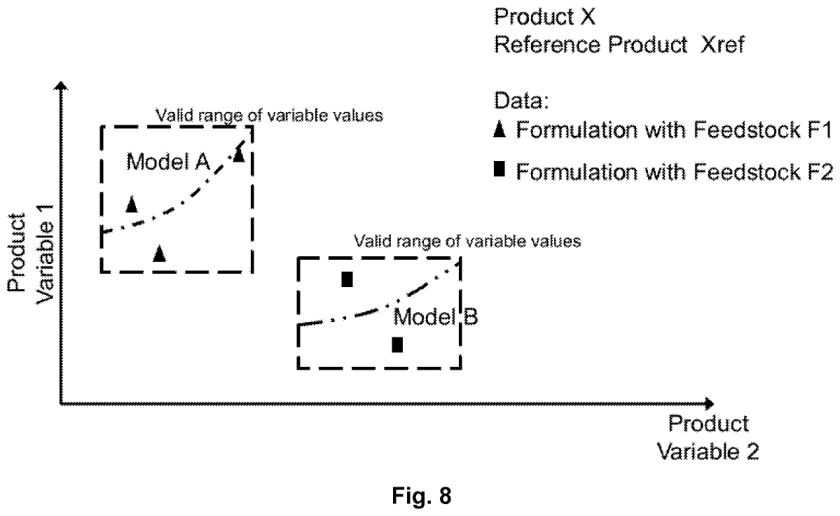

FIG. 8 is a diagram representing product properties models for product x parameterized by independent variables models according to an exemplary embodiment of the present disclosure.

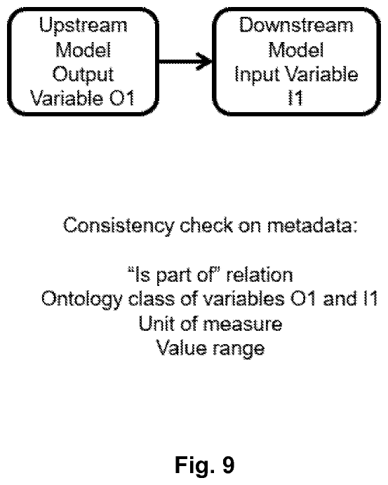

FIG. 9 is a diagram showing connected models according to an exemplary embodiment of the present disclosure.

In the following, further embodiments of the present disclosure are provided:

Embodiment 1. A computer-implemented method (100) for collaborative sustainability impact optimization of manufacturing processes, the method comprising the steps of:
receiving, by the at least one processor and via a communication interface, user input data of at least one chemical product comprising product identifier data, process and feedstock data, sustainability impact metrics data and product property data;
determining a first normalized sustainability impact calculation model for a first user based on the process and feedstock data, the sustainability impact metrics data and the product property data, the first normalized sustainability impact calculation model describing a functional relationship between each one of the sustainability impact metrics data and the product property data for the first user; and determining a second normalized sustainability impact calculation model for a second user based on the process and feedstock data, the sustainability impact metrics data and the product property data, the second normalized sustainability impact calculation model describing a functional relationship between each one of the sustainability impact metrics data and the product property data for the second user;
connecting the first normalized sustainability impact calculation model for the first user and the second normalized sustainability impact calculation model for the second user to a connected normalized sustainability impact calculation model; and
generating, by the at least one processor, a user interface enabling evaluation of connected normalized sustainability impact calculation model over a variable value range in terms of summing up the sustainability impact metrics data and the product property data and, based on the summing up, optimizing the manufacturing processes.

Embodiment 2. The computer-implemented method according to embodiment 1, wherein the step of connecting the first normalized sustainability impact calculation model and the second normalized sustainability impact calculation model to a connected normalized sustainability impact calculation model comprises: mapping selected product properties as output variables from at least one upstream model based on the first normalized sustainability impact calculation model to input variables of at least one downstream model based on the second normalized sustainability impact calculation model.

Embodiment 3. The computer-implemented method according to any one of the preceding embodiments,
wherein the input variables of at least one downstream model are controlled by the first user or the second user; and/or wherein the input variables of at least one upstream model are controlled by the first user or the second user.

Embodiment 4. The computer-implemented method according to any one of the preceding embodiments,
wherein the step of receiving, by the at least one processor and via the communication interface, user input data of at least one chemical product further comprises:
uploading of the user input data of at least one chemical product data using a platform node.

Embodiment 5. The computer-implemented method according to embodiment 4, wherein the step of uploading of the user input data of at least one chemical product data using a platform node comprises uploading the user input data to a secured computing enclave, in which statistical models are fitted by using statistical modeling code provided by an independent third party

Embodiment 6. The computer-implemented method according to any one of the preceding embodiments,
wherein the method further comprises the steps of:
and determining a third normalized sustainability impact calculation model for a third user based on the process and feedstock data, the sustainability impact metrics data and the product property data, the third normalized sustainability impact calculation model describing a functional relationship between each one of the sustainability impact metrics data and the product property data for the third user; and
connecting the first normalized sustainability impact calculation model for the first user and the second normalized sustainability impact calculation model for the second user and the third normalized sustainability impact calculation model for the third user to a connected normalized sustainability impact calculation model.

Embodiment 7. The computer-implemented method according to any one of the preceding embodiments, wherein the step of generating, by the at least one processor, the user interface enabling evaluation of connected normalized sustainability impact calculation model over the variable value range comprises restricting the variable value range to a valid variable value range.

Embodiment 8. A device for collaborative sustainability impact optimization of manufacturing processes, the device comprising:
a communication interface;
at least one processor; and
an user interface;
wherein the communication interface is configured to receive user input data of at least one chemical product comprising product identifier data, process and feedstock data, sustainability impact metrics data and product property data;
wherein the at least one processor is configured to:
determine a first normalized sustainability impact calculation model for a first user based on the process and feedstock data, the sustainability impact metrics data and the product property data, the first normalized sustainability impact calculation model describing a functional relationship between each one of the sustainability impact metrics data and the product property data for the first user; and to
determine a second normalized sustainability impact calculation model for a second user based on the process and feedstock data, the sustainability impact metrics data and the product property data, the second normalized sustainability impact calculation model describing a functional relationship between each one of the sustainability impact metrics data and the product property data for the second user;
to connect the first normalized sustainability impact calculation model for the first user and the second normalized sustainability impact calculation model for the second user to a connected normalized sustainability impact calculation model; and
to generate the user interface, which is configured to enable evaluation of connected normalized sustainability impact calculation model over a variable value range in terms of summing up the sustainability impact metrics data and the product property data, and, based on the summing up, to optimize the manufacturing processes.

Embodiment 9. The device for collaborative sustainability impact optimization of manufacturing processes according to embodiment 8,
wherein the at least one processor is configured to connect the first normalized sustainability impact calculation model and the second normalized sustainability impact calculation model to a connected normalized sustainability impact calculation model by mapping selected product properties as output variables from at least one upstream model based on the first normalized sustainability impact calculation model to input variables of at least one downstream model based on the second normalized sustainability impact calculation model.

Embodiment 10. The device for collaborative sustainability impact optimization of manufacturing processes according to embodiment 8 or embodiment 9, wherein the communication interface is configured to upload the user input data of at least one chemical product data using a platform node.

Embodiment 11. The device for collaborative sustainability impact optimization of manufacturing processes according to any one of the preceding embodiments 8 to 10, wherein the at least one processor is configured to determine a third normalized sustainability impact calculation model for a third user based on the process and feedstock data, the sustainability impact metrics data and the product property data, the third normalized sustainability impact calculation model describing a functional relationship between each one of the sustainability impact metrics data and the product property data for the third user; and wherein the at least one processor is configured to connect the first normalized sustainability impact calculation model for the first user and the second normalized sustainability impact calculation model for the second user and the third normalized sustainability impact calculation model for the third user to a connected normalized sustainability impact calculation model.

Embodiment 12. The device for collaborative sustainability impact optimization of manufacturing processes according to any one of the preceding embodiments 8 to 11, wherein the at least one processor is configured to generate the user interface enabling evaluation of connected normalized sustainability impact calculation model over the variable value range comprises restricting the variable value range to a valid variable value range.

Embodiment 13. Computer program element for instructing a device according to any one of embodiments 8 to 12, which, when being executed by a processing unit, is adapted to perform the method steps of any one of embodiments 1 to 7.

Embodiment 14. Computer readable medium having stored the program element of embodiment 13, preferably the computer readable medium comprising a blockchain.

Embodiment 15. A neural network training method for training a neural network, the neural network adapted to perform the method comprising the method steps as explained by any one of the embodiments 1 to 7 and using training data to train multivariate models in terms of costs and impact reductions and product properties.

Embodiment 16. A neural network trained by the method according to embodiment 15.

All definitions, as defined and used herein, should be understood to control over dictionary definitions, definitions in documents incorporated by reference, and/or ordinary meanings of the defined terms.

The indefinite articles “a” and “an”, as used herein in the specification and in the claims, unless clearly indicated to the contrary, should be understood to mean “at least one”.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either”, “one of”, “only one of”, or “exactly one of”.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

In the claims, as well as in the specification above, all transitional phrases such as “comprising”, “including”, “carrying”, “having”, “containing”, “involving”, “holding”, “composed of”, and the like are to be understood to be open-ended, i.e., to mean including but not limited to. Only the transitional phrases “consisting of” and “consisting essentially of” shall be closed or semi-closed transitional phrases, respectively.

Furthermore, in this detailed description, a person skilled in the art should note that quantitative qualifying terms such as “generally”, “substantially”, “mostly”, and other terms are used, in general, to mean that the referred to object, characteristic, or quality constitutes a majority of the subject of the reference. The meaning of any of these terms is dependent upon the context within which it is used, and the meaning may be expressly modified.

In another exemplary embodiment of the present disclosure, a computer program or a computer program element is provided that is characterized by being adapted to execute the method steps of the method according to one of the preceding embodiments, on an appropriate system. The computer program element might therefore be stored on a computer unit, which might also be part of an embodiment of the present disclosure. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the disclosure.

This exemplary embodiment of the disclosure covers both, a computer program that right from the beginning uses the disclosure and a computer program that by means of an up date turns an existing program into a program that uses the disclosure.

Further on, the computer program element might be able to provide all necessary steps to fulfil the procedure of an exemplary embodiment of the method as described above. According to a further exemplary embodiment of the present disclosure, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. The computer program may also be distributed by printing the source code in a book, e.g. “Numerical Recipes”.

According to a further exemplary embodiment of the present disclosure, a medium for making a computer program element available for downloading is provided, which computer program element is arranged to perform a method according to one of the previously described embodiments of the disclosure.

All features can be combined to provide a synergetic effect that is more than the simple summation of the features.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used.

Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed.

Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A computer-implemented method for collaborative environmental impact optimization of manufacturing processes, the method comprising the steps of:
receiving, by at least one processor and via a communication interface, first input data relating to at least one chemical product comprising environmental impact metrics data related to environmental impact metrics and product property data related to chemical or physical properties of the at least one chemical product; and second input data relating to at least one chemical product comprising environmental impact metrics data related to environmental impact metrics and product property data related to chemical or physical properties of the at least one chemical product;
determining a first normalized environmental impact calculation model for the first input data, the first normalized environmental impact calculation model describing a functional relationship between the environmental impact metrics data and the product property data; and
determining a second normalized environmental impact calculation model for the second input data, the second normalized environmental impact calculation model describing a functional relationship between the environmental impact metrics data and the product property data;
connecting the first normalized environmental impact calculation model and the second normalized environmental impact calculation model to a connected normalized environmental impact calculation model; and
providing, by the at least one processor, output data of the connected normalized environmental impact calculation model over a variable value range, and based on the output data optimizing the manufacturing processes.

2. The computer-implemented method according to claim 1, wherein the first and second input data relating to the at least one chemical product further comprises product identifier data, process and/or feedstock data.

3. The computer-implemented method according to claim 1, wherein the step of connecting the first normalized environmental impact calculation model and the second normalized environmental impact calculation model to a connected normalized environmental impact calculation model comprises: mapping selected product properties as output variables from at least one upstream model based on the first normalized environmental impact calculation model to input variables of at least one downstream model based on the second normalized environmental impact calculation model.

4. The computer-implemented method according to claim 3, wherein the input variables of at least one downstream model are controlled by a first data owner or a second data owner; and/or wherein the input variables of at least one upstream model are controlled by the first data owner or the second data owner.

5. The computer-implemented method according to claim 1, wherein the step of receiving, by the at least one processor and via the communication interface, input data of at least one chemical product further comprises: uploading of the input data of at least one chemical product data using a platform node.

6. The computer-implemented method according to claim 5, wherein the step of uploading of the input data of at least one chemical product data using a platform node comprises uploading the input data to a secured computing enclave, in which statistical models are fitted by using statistical modeling code provided by an independent third party.

7. The computer-implemented method according to claim 1, wherein the method further comprises the steps of:
determining a third normalized environmental impact calculation model for third input data based on the environmental impact metrics data and the product property data, the third normalized environmental impact calculation model describing a functional relationship between the environmental impact metrics data and the product property data; and
connecting the first normalized environmental impact calculation model for the first input data and the second normalized environmental impact calculation model for the second input data and the third normalized environmental impact calculation model for the third input data to a connected normalized environmental impact calculation model.

8. The computer-implemented method according to claim 1, wherein the step of providing, by the at least one processor, output data of the connected normalized environmental impact calculation model over a variable value range comprises restricting the variable value range to a valid and/or a predetermined variable value range.

9. An apparatus for collaborative environmental impact optimization of manufacturing processes, the apparatus comprising:
one or more computing nodes and one or more computer-readable media having thereon computer-executable instructions that are structured such that, when executed by the one or more computing nodes, cause the apparatus to perform the following steps:
receiving, by at least one processor and via a communication interface, first input data relating to at least one chemical product comprising environmental impact metrics data related to environmental impact metrics and product property data related to chemical or physical properties of the at least one chemical product; and second input data relating to at least one chemical product comprising environmental impact metrics data related to environmental impact metrics and product property data related to chemical or physical properties of the at least one chemical product;
determining a first normalized environmental impact calculation model for the first input data, the first normalized environmental impact calculation model describing a functional relationship between the environmental impact metrics data and the product property data; and
determining a second normalized environmental impact calculation model for the second input data, the second normalized environmental impact calculation model describing a functional relationship between the environmental impact metrics data and the product property data;
connecting the first normalized environmental impact calculation model and the second normalized environmental impact calculation model to a connected normalized environmental impact calculation model; and
providing, by the at least one processor, output data of the connected normalized environmental impact calculation model over a variable value range, and based on the output data optimizing the manufacturing processes.

10. The apparatus for collaborative environmental impact optimization of manufacturing processes, according to claim 9,
wherein the at least one processor is configured to connect the first normalized environmental impact calculation model and the second normalized environmental impact calculation model to a connected normalized environmental impact calculation model by mapping selected product properties as output variables from at least one upstream model based on the first normalized environmental impact calculation model to input variables of at least one downstream model based on the second normalized environmental impact calculation model.

11. The apparatus for collaborative environmental impact optimization of manufacturing processes according to claim 9,
wherein the communication interface is configured to upload the input data of at least one chemical product data using a platform node.

12. The apparatus for collaborative environmental impact optimization of manufacturing processes according to claim 9,
wherein the at least one processor is configured to determine a third normalized environmental impact calculation model for third input data based on the environmental impact metrics data and the product property data, the third normalized environmental impact calculation model describing a functional relationship between each one of the environmental impact metrics data and the product property data; and
wherein the at least one processor is configured to connect the first normalized environmental impact calculation model for the first input data and the second normalized environmental impact calculation model for the second input data and the third normalized environmental impact calculation model for the third input data to a connected normalized environmental impact calculation model.

13. The apparatus for collaborative environmental impact optimization of manufacturing processes according to claim 9,
wherein the at least one processor is configured to provide output data of the connected normalized environmental impact calculation model over a variable value range, and based on the output data optimizing the manufacturing processes.

14. A computer element with instructions, which when executed on one or more computing node(s) is configured to carry out the steps of the method of claim 1.

15. Computer readable medium having stored the program element of claim 14.

16. A neural network training method for training a neural network, the neural network adapted to perform the method comprising the method steps of claim 1, and using training data to train multivariate models in terms of costs and environmental impact reductions and product properties.

17. A neural network trained by the method according to claim 16.
